(19) United States
(12) Patent Application Publication
(10) Pub. No.: US 2013/0238478 A1
(43) Pub. Date: Sep. 12, 2013

(54) SYSTEM AND METHOD FOR PROVIDING DEBT SECURITIES DENOMINATED IN VIRTUAL CURRENCIES

(71) Applicant: Daniel B. Bruno, Lewes, DE (US)

(72) Inventor: Daniel B. Bruno, Lewes, DE (US)

(21) Appl. No.: 13/412,758

(22) Filed: Mar. 6, 2012

(51) Int. Cl. G06Q 40/04

(52) U.S. Cl. 705/37

(57) ABSTRACT

The present invention generally relates to provision of debt securities and other securities/commodity trading instruments. In particular, embodiments of the invention relate to a computer implemented system and method for providing debt securities, options and other securities/commodity trading instruments denominated in a virtual currency.

### FIELD OF THE INVENTION

The present invention generally relates to provision of debt securities and other securities/commodity trading instruments. In particular, embodiments of the invention relate to a computer implemented system and method for providing debt securities, options and other securities/commodity trading instruments denominated in a virtual currency.

### BACKGROUND

Economic markets are evolving at an ever increasing pace. The ability to buy and sell goods, securities, services, debt instruments and other complex financial instruments in a variety of fiat currencies has become standard practice in financial markets around the world. One problem with current market practices is tying these financial products to the price of one or more fiat currencies that fluctuate drastically based on any number of criteria.

From speculation to government currency control programs, such as quantitative easing seen in the United States and competitive devaluation seen in China, monetary policies of governments and actions of investors or investment groups (e.g., hedge funds) create a fluctuating marketplace where the only certainty is uncertainty. In these environments, it can be hard to provide stability and safe investments based on currencies.

In addition, with the move to a more global marketplace, it has become ever apparent that actions of state actors can directly affect currency markets, commodity markets and the markets for securities and other financial instruments. Since there is a synergy between the markets, news from one region can in turn impact the entire global marketplace.

Recently, there has been a concept to put forward one or more decentralized currencies that are not tied to or issued by a state or union of states. In this manner, currency can be controlled by the marketplace, as opposed to the actions of one or more governments. There are certain advantages and disadvantages to this methodology, such topics are beyond the scope of the present application.

While attempts at offering decentralized “virtual” currencies, which are comprised of electronically stored and formatted currencies, have met with some success, current implementations have been only rudimentarily used. For instance, virtual currencies are currently only used for the purchase and sale of goods and services. These currencies are also specifically susceptible to simple fluctuations (e.g., speculation, pump and dump schemes) and lack the systems needed to control volatility and handle complex economic scenarios, such as inflation/deflation, “runs on the bank,” counterfeiting and fraud.

Therefore, there is need in the art for a computer implemented system and method for providing debt securities, options and other securities/commodity trading instruments denominated in a virtual currency as well as providing methods for controlling volatility and other effects of complex economic scenarios. These and other features and advantages of the present invention will be explained and will become obvious to one skilled in the art through the summary of the invention that follows.

### SUMMARY OF THE INVENTION

Accordingly, it is an aspect of the present invention to provide a computer implemented system and method for providing debt securities, options and other securities/commodity trading instruments denominated in a virtual currency as well as providing methods for controlling volatility and other effects of complex economic scenarios.

According to an embodiment of the present invention, a web based system for providing debt securities in a virtual currency includes one or more data stores configured to store a debt security instrument, wherein said debt security instrument is denominated in said virtual currency, wherein said debt security instrument is pregnant with said virtual currency, wherein said debt security instrument comprises one or more identifiers configured to associate said debt security instrument to an investor; a business web application server operatively coupled to the one or more data stores; a first memory in the business web application server, the first memory containing computer-executable code that, when processed by one or more computing devices, performs steps comprising: receiving a request from said investor regarding said debt security instrument, wherein said request comprises request information associated with a potential transaction; matching said investor to said debt security instrument via one or more of said one or more identifiers; generating a transaction from said request information, wherein said transaction effects a change on said debt security instrument; recording said change to one or more of said one or more data stores; and transmitting to said investor a confirmation associated with said change.

According to an embodiment of the present invention, the one or more data stores are decentralized.

According to an embodiment of the present invention, the at least one of the one or more computing devices is the business web application server.

According to an embodiment of the present invention, the one or more computing devices are connected in a decentralized manner.

According to an embodiment of the present invention, the transaction comprises a transfer of said debt security instrument.

According to an embodiment of the present invention, the transaction comprises a maturity event.

According to an embodiment of the present invention, the one or more identifiers comprise non-personal information associated with the investor.

According to an embodiment of the present invention, a web based method for providing debt securities in a virtual currency includes the steps of receiving, at one or more computing devices, a request from an investor regarding a debt security instrument, wherein said request comprises request information associated with a potential transaction; matching, at said one or more computing devices, said investor to said debt security instrument via one or more identifiers configured to associate said debt security instrument to said investor, wherein said one or more identifiers are stored in one or more data stores configured to store said debt security instrument, wherein said debt security instrument is denominated in said virtual currency, wherein said debt security instrument is pregnant with said virtual currency; generating a transaction from said request information, wherein said transaction effects a change on said debt security instrument; recording said change to one or more of said one or more data stores; and transmitting to said investor a confirmation associated with said change.

According to an embodiment of the present invention, the one or more data stores are decentralized.

According to an embodiment of the present invention, the at least one of the one or more computing devices is a business web application server.

According to an embodiment of the present invention, the one or more computing devices are decentralized.

According to an embodiment of the present invention, the transaction comprises a transfer of said debt security instrument.

According to an embodiment of the present invention, the transaction comprises a maturity event.

According to an embodiment of the present invention, the one or more identifiers comprise non-personal information associated with the investor.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention; and

FIG. 3 is a flowchart of an exemplary method in accordance with an embodiment of the present invention.

### DETAILED SPECIFICATION

The present invention generally relates to provision of debt securities, options and other securities/commodity trading instruments. In particular, embodiments of the invention relate to a computer implemented system and method for providing debt securities, options and other securities/commodity trading instruments denominated in a virtual currency as well as providing methods for controlling volatility and other effects of complex economic scenarios.

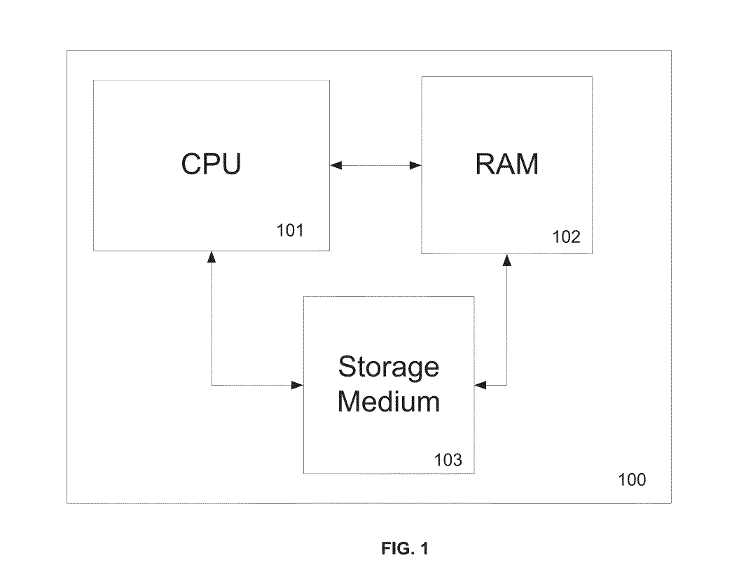

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

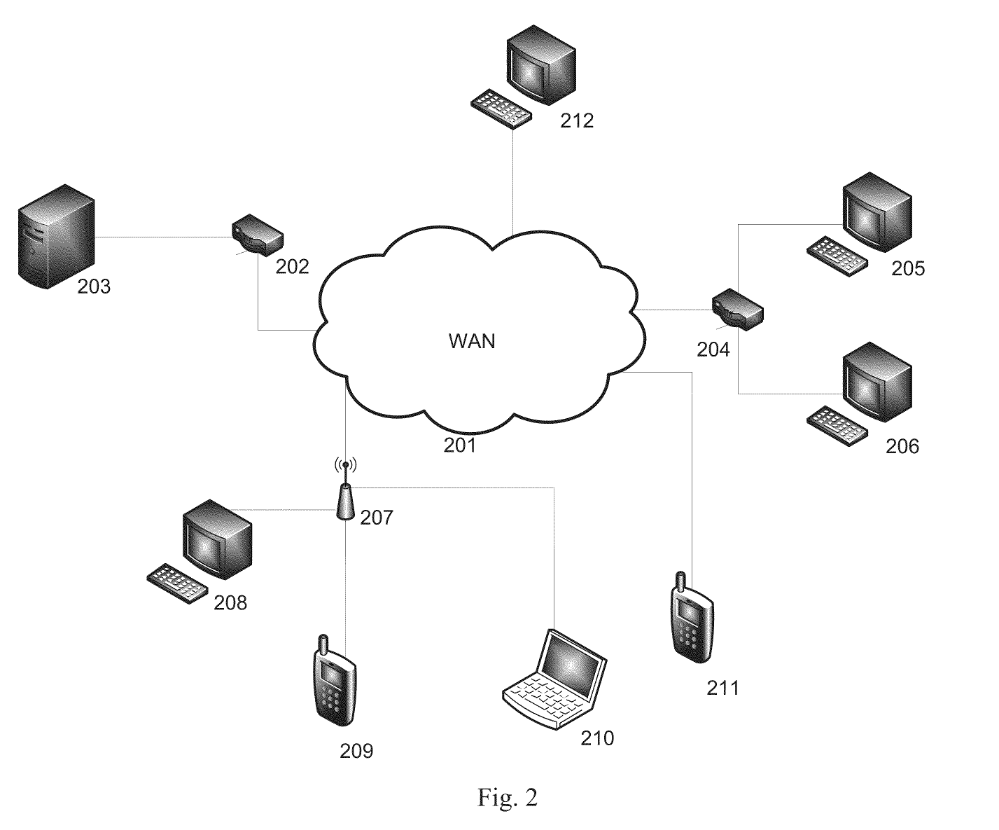

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

In a preferred embodiment of the present invention, the system may be comprised of decentralized computing devices operatively connected across one or more networks. In this configuration, data stores and processing computing devices may be utilized to maintain stability and geographic independence allowing for the system to be maintained by a plurality of computing devices distributed in multiple jurisdictions, making tracking, tracing, disabling or other negative action virtually impossible as the data and transactional processing power is distributed in a non-centralized manner. This decentralization offers protection from actions taken by governments to neutralize one or more components of the invention, thereby providing stability and reliability to the systems described herein.

Even when using a decentralized system setup, one or more of the components may be utilized as an access point to the system. For instance, a business web application server may be utilized as an access point or node to other computing devices that handle the storage and processing of the information. In alternate embodiments, the entire storage and processing may take place entirely on the business web application server. One of ordinary skill in the art would appreciate that there are numerous combinations of computing devices and data stores that could be utilized with embodiments of the present invention, and embodiments of the present invention are contemplated for use with any combination of computing devices and data stores.

According to an embodiment of the present invention, the system described herein is configured to provide investors the ability to create, utilize, trade and otherwise process debt security instruments, options and other securities/commodity trading instruments denominated in a virtual (i.e., electronic) currency. While embodiments of the present invention can be utilized with any virtual currency, preferred embodiments of the present invention are designed for sue with virtual currencies that are designed and maintained in a manner to prevent abuse, misuse and volatility. For instance, embodiments of the present invention may be utilized with Swiftcoins™. Swiftcoins are a decentralized electronic currency that utilizes tools and systems to smooth exchange rate volatility and handle other concerns associated with decentralized electronic currencies previously noted herein. Further Swiftcoins utilize a system for eroding value of the electronic currency over time, mimicking certain real world effects (e.g., inflation). In conjunction with the user of Swiftcoins, a preferred embodiment of the present invention may be utilized with a debt security instrument known as a Solidus Bond™, which is the debt security instrument identified and utilized in the preferred embodiment descriptions herein.

According to an embodiment of the present invention, providing debt instruments, options and other securities/commodity trading instruments denominated in a virtual currency offers many advantageous over the present art. First, the system herein described achieves the first move towards use of virtual currencies for the purchase and sale of complex investment and debt instruments and a move away from simplistic transactions with respect to virtual currencies (e.g., buy/sell goods/services). In this manner, debt instruments, options and other securities/commodity trading instruments denominated in virtual currencies offer a maturity and growth of the medium in a manner not seen before.

Another advantage the present system with respect to the provision of debt instruments, options and other securities/commodity trading instruments denominated in a virtual currency is that the system is configured to allow for these debt instruments, options and other securities/commodity trading instruments to be pregnant with the virtual currency. In this manner, virtual currency denominated debt instruments, options and other securities/commodity trading instruments cannot default. This simply is not possible with fiat currencies or other instruments based on gold or other physical assets.

Yet another advantage of the present system is that ownership and control of the various debt instruments, options and other securities/commodity trading instruments and debt security instruments may be done in a much more abstract sense than those regulated by states and governmental organizations. For instance, debt instruments, options and other securities/commodity trading instruments could be maintained without requirements to have an investors name or any other identifying information other than some limited amount of information that would allow the investor to locate and access the debt instrument, option or other securities/commodity trading instrument. For instance, identifying information could be a username and a password. Other forms of identifying information include, but are not limited to, numbers from rolling number generators, biometric information (e.g., fingerprint, retina scan) and decodable passwords or checksums. One of ordinary skill in the art would appreciate that there are numerous types of identifying information that could be utilized with embodiments of the present invention, and embodiments of the present invention are contemplated for use with any type of identifying information.

Since investment instruments (e.g., debt securities, options and other securities/commodity trading instruments) in this manner are hard to trace, due to a lack of required personal information (e.g., Social Security Number, name, address), a level of anonymity is provided, allowing for investors to maintain their finances in confidence. Additionally, since each transaction is not recorded by states or government entities, nor are transactions, in preferred embodiments, recorded in a centralized manner, the level of anonymity is further enhanced. As noted, in preferred embodiments of the present invention, only a limited number of confirmations are stored across the numerous decentralized data stores and/or computing devices. As the system grows, tracking back each transaction becomes more and more complicated, especially when coupling each transaction recordation with one or more encryption or cryptographic protocols.

Exemplary Embodiments

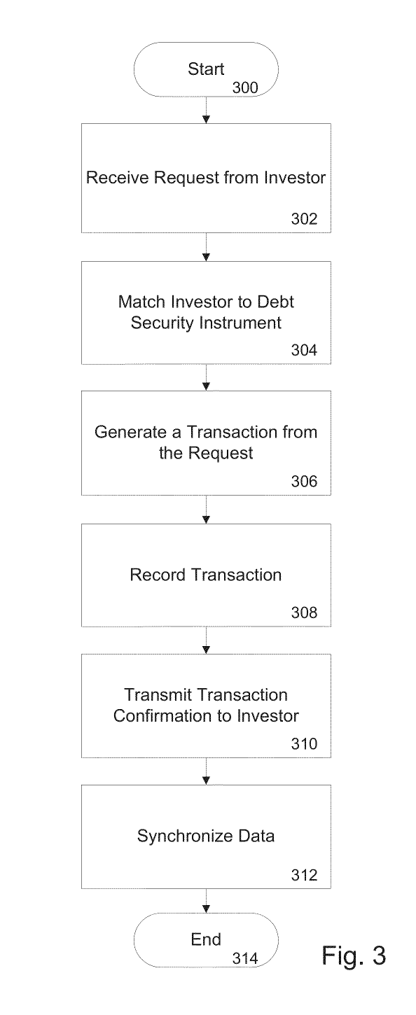

The following is an exemplary embodiment of a method for generating and delivering an event, as shown in FIG. 3. At step 300, the process starts with an investor attempting to access the system and conduct a request. Typically, this is effected by having the investor utilize a computing device to contact a business web application server in order to initially interact with the system and submit the request.

At step 302, the system received the request from the investor. Again, typically this occurs at the business web application server, but may also occur at any number of computing devices associated with the processing of information for the system. The request will be comprised of information, such as one or more identifiers allowing the system to identify the debt instrument associated with the investor. The request will be further comprised of information with regards to what kind of transaction the user wishes to effect on the debt instrument.

At step 304, the system utilizes the one or more identifiers to match the investor to the appropriate debt instrument. As described above, this could include matching the user's login information or other security information verifying the investor has access to a particular debt instrument.

At step 306, the system generates a transaction from the request information. Transactions could include, but are not limited to, redemption requests, purchase requests, transfer requests, termination requests, status report requests and update information requests. One of ordinary skill in the art would appreciate that there are numerous requests/transactions types that could be utilized with embodiments of the present invention, and embodiments of the present invention are contemplated for use with any type of request/transaction.

At step 308, the system has processed the appropriate transaction and effects the recordation of the transaction in one or more data stores associated with the debt security. In certain embodiments, the system may be configured to record the transaction in the same data stores that originally stored the debt instrument. In alternate embodiments, after each transaction, the debt instrument may be transferred or stored in one or more alternative data stores. In this manner, the system can continue to distribute the data over multiple data stores, creating a level of redundancy (in case a data store ceases to function or goes offline) while also increasing the difficulty of tracking back transactions as they are spread out over numerous data stores.

At step 310, the system transmits to the investor a confirmation that the request was either processed successfully or was unable to be processed. In certain embodiments, the system may be configured to provide the investor with additional information regarding the debt instrument or why the request was unsuccessful. For instance, if an access point for the debt instrument changed, the investor may be provided with information about the new location (i.e., data store) of the debt security instrument.

At step 312, while optional, the system may be configured to synchronize transaction data after the completion of a transaction (or the failure to complete a transaction). In this manner, the system may be configured to synchronize data across computing devices and data stores so that a failure in one of the computing devices or data stores does not affect the loss of the transaction or the debt instrument. At step 314, the process terminates.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for providing debt securities denominated in a virtual currency, the system comprising:
one or more data stores configured to store a debt security instrument,
wherein said debt security instrument is denominated in said virtual currency,
wherein said debt security instrument is pregnant with said virtual currency,
wherein said debt security instrument comprises one or more identifiers configured to associate said debt security instrument to an investor;
a business web application server operatively coupled to the one or more data stores;
a first memory in the business web application server, the first memory containing computer-executable code that, when processed by one or more computing devices, performs steps comprising:
receiving a request from said investor regarding said debt security instrument,
wherein said request comprises request information associated with a potential transaction;
matching said investor to said debt security instrument via one or more of said one or more identifiers;
generating a transaction from said request information,
wherein said transaction effects a change on said debt security instrument;
recording said change to one or more of said one or more data stores; and
transmitting to said investor a confirmation associated with said change.

2. The web-based system of claim 1, wherein said one or more data stores are decentralized.

3. The web-based system of claim 1, wherein at least one of the one or more computing devices is the business web application server.

4. The web-based system of claim 1, wherein the one or more computing devices are decentralized.

5. The web-based system of claim 1, wherein said transaction comprises a transfer of said debt security instrument.

6. The web-based system of claim 1, wherein said transaction comprises a maturity event.

7. The web-based system of claim 1, wherein said one or more identifiers comprise non-personal information associated with the investor.

9. A web-based method for providing debt securities denominated in a virtual currency, the method comprising the steps of:
receiving, at one or more computing devices, a request from an investor regarding a debt security instrument,
wherein said request comprises request information associated with a potential transaction;
matching, at said one or more computing devices, said investor to said debt security instrument via one or more identifiers configured to associate said debt security instrument to said investor,
wherein said one or more identifiers are stored in one or more data stores configured to store said debt security instrument,
wherein said debt security instrument is denominated in said virtual currency,
wherein said debt security instrument is pregnant with said virtual currency;
generating a transaction from said request information,
wherein said transaction effects a change on said debt security instrument;
recording said change to one or more of said one or more data stores; and
transmitting to said investor a confirmation associated with said change.

10. The web-based method of claim 9, wherein said one or more data stores are decentralized.

11. The web-based method of claim 9, wherein at least one of the one or more computing devices is a business web application server.

12. The web-based method of claim 9, wherein the one or more computing devices are decentralized.

13. The web-based method of claim 9, wherein said transaction comprises a transfer of said debt security instrument.

14. The web-based method of claim 9, wherein said transaction comprises a maturity event.

15. The web-based method of claim 9, wherein said one or more identifiers comprise non-personal information associated with the investor.
